(19) United States
(12) Patent Application Publication
(10) Pub. No.: US 2008/0259805 A1
(43) Pub. Date: Oct. 23, 2008

(54) METHOD AND APPARATUS FOR MANAGING NETWORKS ACROSS MULTIPLE DOMAINS

(76) Inventors: John Andrew Canger, Lake Zurich, IL (US); Chin-Wang Chao, Lincroft, NJ (US); Barry McKay Crooks, Maitland, FL (US); Shadi Haidar, Brooklyn, NY (US); Wen-Jui Li, Bridgewater, NJ (US); David H. Lu, Morganville, NJ (US); Angelo Napoli, Princeton, NJ (US)

Correspondence Address: PATTERSON & SHERIDAN, LLP;Suite 100, 595 Shrewsbury Avenue, Shrewsbury, NJ, 07702, US

(21) Appl. No.: 11/736,326

(22) Filed: Apr. 17, 2007

(51) Int. Cl. H04J 3/14

(52) U.S. Cl. 370/242; 370/401

(57) ABSTRACT

A method and apparatus for managing networks across multiple domains are disclosed. For example, the method stores a mapping table that correlates one or more Customer Edge Routers (CERs) with one or more Route Processing Modules (RPMs) in at least one seed-file distributor, where each of the one or more Customer Edge Routers (CERs) is monitored by one of the at least one availability manager. The method receives an alarm associated with one of the one or more RPMs that affects one of the one or more CERs, where the alarm is received by one of the at least one availability manager that is monitoring the affected one of the one or more CERs. The method then provides a status associated with the one of said one or more RPMs in accordance with the alarm.

The present invention relates generally to communication networks and, more particularly, to a method and apparatus for managing networks across multiple domains for packet networks, e.g., managed Virtual Private Networks (VPN), Internet Protocol (IP) networks, etc.

### BACKGROUND OF THE INVENTION

An enterprise customer may build a Virtual Private Network (VPN) by connecting multiple sites or users over a network of a network service provider. The enterprise VPN and customer premise equipment such as Customer Edge Routers (CERs) may be managed by the network service provider. For example, when the network service provider manages the VPNs and CERs, the CERs are connected to the network service provider's Asynchronous Transfer Mode (ATM) and/or Frame Relay (FR) network through a Provider Edge Router (PER). In providing managed networking services, the network service provider often deploys one or more availability management systems for managing the customer premise equipment, e.g., a CER. When a failure occurs in the ATM/FR network, the failure may affect one or more customers. However, the customer and network related troubles may not be correlated resulting in multiple reports/tickets for the same root cause. Resolution of each ticket/trouble requires time and cost.

Therefore, there is a need for a method that provides management of networks across multiple domains.

### SUMMARY OF THE INVENTION

In one embodiment, the present invention discloses a method and apparatus for managing networks across multiple domains. For example, the method stores a mapping table that correlates one or more Customer Edge Routers (CERs) with one or more Route Processing Modules (RPMs) in at least one seed-file distributor, where each of the one or more Customer Edge Routers (CERs) is monitored by at least one availability manager. The method receives an alarm associated with one of the one or more RPMs that affects one of the one or more CERs, where the alarm is received by one of the at least one availability manager that is monitoring the affected one of the one or more CERs. The method then provides a status associated with the one of said one or more RPMs in accordance with the alarm.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the present invention;

FIG. 2 illustrates an exemplary network for managing networks across multiple domains;

FIG. 3 illustrates a flowchart of a method for managing networks across multiple domains; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for managing one or more networks across multiple domains. Although the present invention is discussed below in the context of packet networks, the present invention is not so limited. Namely, the present invention can be applied for other networks using a similar architecture with route processing modules.

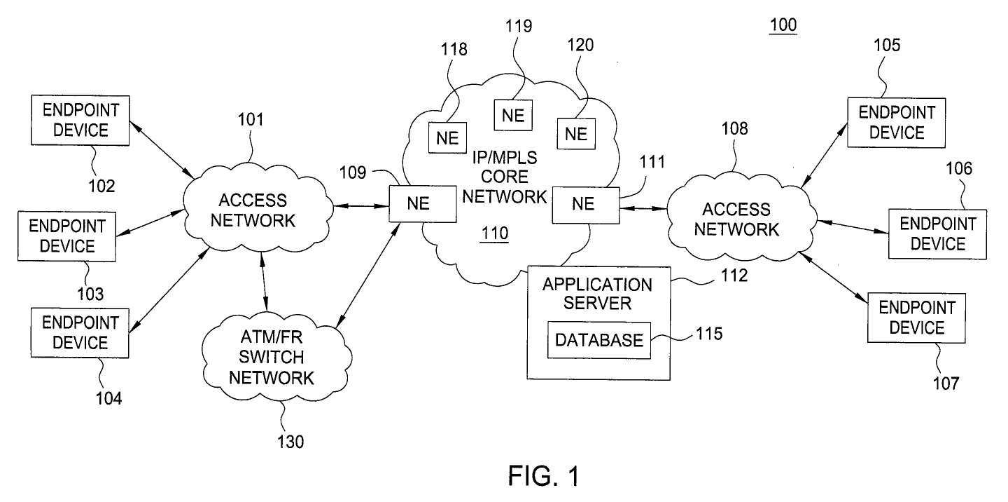

FIG. 1 is a block diagram depicting an exemplary packet network 100 related to the current invention. Exemplary packet networks include Internet protocol (IP) networks, Asynchronous Transfer Mode (ATM) networks, frame-relay networks, and the like. An IP network is broadly defined as a network that uses Internet Protocol such as IPv4 or IPv6 to exchange data packets.

In one embodiment, the packet network may comprise a plurality of endpoint devices 102-104 configured for communication with a core packet network 110 (e.g., an IP based core backbone network supported by a service provider) via an access network 101. Similarly, a plurality of endpoint devices 105-107 are configured for communication with the core packet network 110 via an access network 108. The network elements 109 and 111 may serve as gateway servers or edge routers for the network 110.

The endpoint devices 102-107 may comprise customer endpoint devices such as personal computers, laptop computers, Personal Digital Assistants (PDAs), servers, routers, and the like. The access networks 101 and 108 serve as a means to establish a connection between the endpoint devices 102-107 and the NEs 109 and 111 of the IP/MPLS core network 110. The access networks 101 and 108 may each comprise a Digital Subscriber Line (DSL) network, a broadband cable access network, a Local Area Network (LAN), a Wireless Access Network (WAN), and the like.

The access networks 101 and 108 may be either directly connected to NEs 109 and 111 of the IP/MPLS core network 110 or through an Asynchronous Transfer Mode (ATM) and/or Frame Relay (FR) switch network 130. If the connection is through the ATM/FR network 130, the packets from customer endpoint devices 102-104 (traveling towards the IP/MPLS core network 110) traverse the access network 101 and the ATM/FR switch network 130 and reach the border element 109.

Some NEs (e.g., NEs 109 and 111) reside at the edge of the core infrastructure and interface with customer endpoints over various types of access networks. An NE that resides at the edge of a core infrastructure is typically implemented as an edge router, a media gateway, a border element, a firewall, a switch, and the like. An NE may also reside within the network (e.g., NEs 118-120) and may be used as a mail server, a honeypot, a router, an application server or like device. The IP/MPLS core network 110 also comprises an application server 112 that contains a database 115. The application server 112 may comprise any server or computer that is well known in the art, and the database 115 may be any type of electronic collection of data that is also well known in the art. Those skilled in the art will realize that although only six endpoint devices, two access networks, and five network elements are depicted in FIG. 1, the communication system 100 may be modified to employ any number of endpoint devices, access networks, border elements, without limiting the scope of the present invention.

The above IP network is described to provide an illustrative environment in which packets for voice and data services are transmitted on networks. An enterprise customer may build a Virtual Private Network (VPN) by connecting multiple sites or users over a network of a network service provider. The enterprise VPN may be managed either by the customer or the network service provider. The cost of managing a VPN by a customer includes at least the cost associated with acquiring networking expertise and the cost of deploying network management systems for the various customer premise equipment. The cost of dedicated networking expertise and management systems is often prohibitive. Hence, more and more enterprise customers are requesting their network service provider to manage their VPNs and customer premise equipment such as Customer Edge Routers (CERs).

The CERs are connected to the network service provider's ATM/FR network through a Provider Edge Router (PER). The ATM/FR network may contain Layer 2 switches that also contain one or more Layer 3 PERs with a Route Processing Module (RPM) that converts Layer 2 frames to Layer 3 Internet Protocol (IP) frames. The RPM enables the transfer of packets from a Layer 2 Permanent Virtual Connection (PVC) circuit to an IP network which is connection less.

In providing managed networking services, the network service provider often deploys one or more availability management systems for managing the customer premise equipment, e.g., CER. The route processing module that interacts with the CER may be a Layer 3 blade added on a Layer 2 switch. The route processing module may then be managed on a separate platform. For example, a separate server for fault notification may be provided for the RPM blades. When a failure occurs in the ATM/FR network, e.g., a failure of a PER with an RPM, the failure may affect customer edge routers. However, since the RPMs and the customer edge routers are managed in separate platforms, no correlation may be made between customer related and network related troubles. For example, one or more customers may report failures and generate tickets. If the trouble is due to a failure of an RPM, a ticket may also be generated by the network managing the RPM. Resolution of each ticket requires time and cost. Therefore, there is a need for a method that provides management of networks across multiple domains.

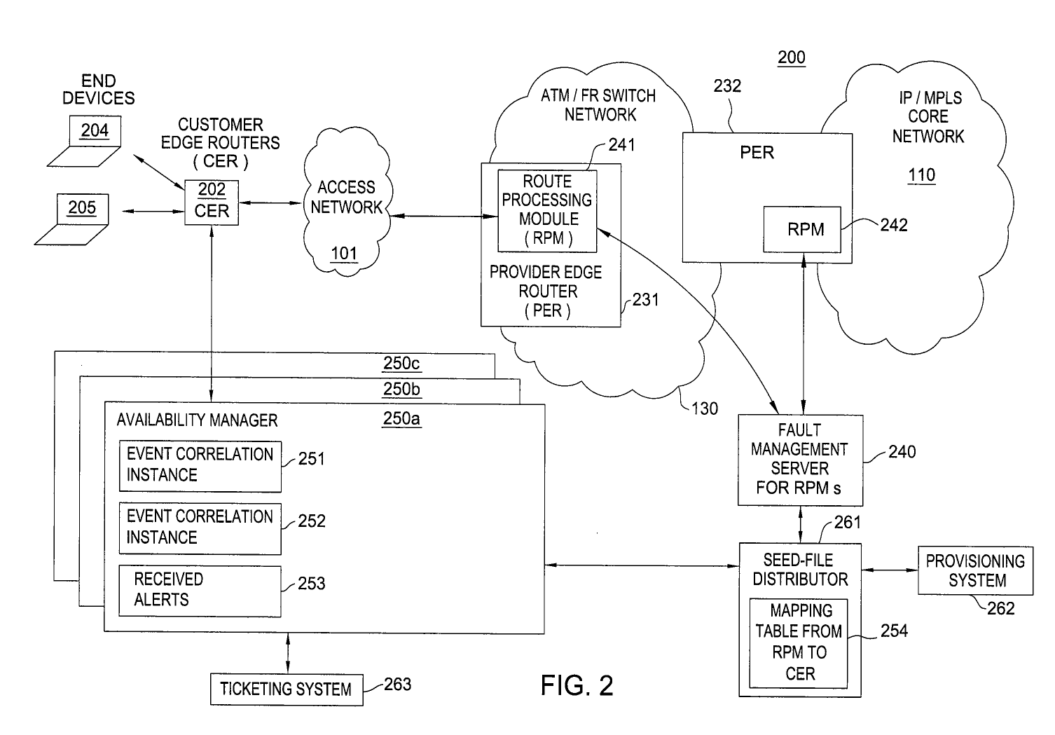

In one embodiment, the current invention provides a method for managing networks across multiple domains using an end-to-end topology data. FIG. 2 illustrates an exemplary network 200 of the current invention for managing networks across multiple domains. For example, customer endpoint devices 204 and 205 are connected to a CER 202 for sending and receiving packets to and from IP/MPLS core network 110. The CER 202 is connected to an ATM/FR switch network 130 via an access network 101. The ATM/FR network 130 may contain PERs 231 and 232. In one embodiment, the PERs 231 and 232 contain RPMs 241 and 242, respectively. RPM 242 serves as a border element for the IP/MPLS core network 110. Packets from CER 202 reach the IP/MPLS core network 110 through the ATM/FR switch network 130 and RPM 242.

In one embodiment, the customer edge router 202 is managed by an availability manager 250a. It should be noted that although only one CER is shown in FIG. 2, any number of CERs can be deployed. It should also be noted that the various CERs may be managed by one or more availability managers, e.g., 250a, 250b, or 250c (broadly referred to as 250). In one embodiment, the availability manager 250a may contain a plurality of event correlation instances, e.g., event correlation instances 251 and 252 for the two networks that it manages. An event correlation instance contains an instance of the availability management system and a notification adaptor for the instance of the availability management system. In one example, an event correlation instance may be created for each enterprise customer or each VPN. In another example, an event correlation instance may be created for a collection of CERs for a service.

In one embodiment, the availability manager 250 contains a module 253 for storing received alerts. The availability manager 250 is also connected to a ticketing system 263 for resolving the received alerts. A seed-file distribution server or distributor 261 is connected to the availability manager 250 to push down changes from a provisioning system 262. In one embodiment, the seed-file distributor 261 also contains a mapping table 254 for storing RPM to CER mapping created from end-to-end topologies. RPMs 241 and 242 are managed by a fault management server 240 for RPMs. The fault management server 240 for RPMs is connected to the seed-file distributor 261.

In one embodiment, the current invention provides a method to manage networks across multiple domains using an end-to-end topology. For example, the method first creates an end-to-end topology between RPMs and CERs. For various interconnections of CERs to RPMs, various end-to-end topologies are created. As such, the method may also create a mapping table from the end-to-end topologies. The RPMs are instrumented in an instance of the availability manager residing in the seed-file distributor acting as an IP availability manager that works with existing proxy in the seed-file distributor. The various mapping tables created from end-to-end topologies are consolidated to create the mapping table in the seed-file distributor.

In operation, when a notification (e.g., an alarm) for an RPM is received by the fault management server 240 for the RPMs, the fault management server captures and forwards the received notification to the seed-file distributor 261. The fault management server 240 for the RPMs filters received notifications to isolate those that may affect customers. For example, the filtration may include processing a failure against sub-interface identifications that could impact one or more customers and ignoring notifications that do not impact any customers.

In one embodiment, the notification may contain: whether or not a line is “up” or “down”, whether or not a sub-interface is shut or not-shut, whether or not a link is “up” or “down”, the RPM name, a severity measure, and a sub-interface identification. The seed-file distributor server then toggles the status of each RPM to “up” or “down” in accordance with received notification(s). The seed-file distribution server 261 then distributes the received notifications to one or more impacted availability managers. The availability manager using the correlation of RPMs and CERs determines the CERs affected by a received failure notification and may provide the information to a ticketing system 263 or to a customer notification system.

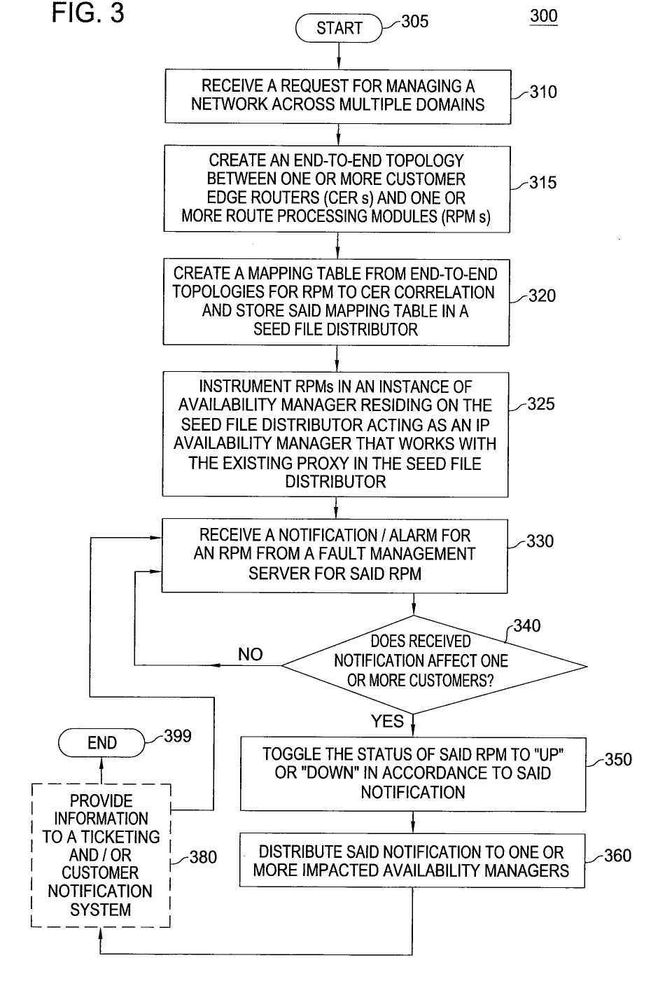

FIG. 3 illustrates a flowchart of a method 300 for managing networks across multiple domains. Method 300 starts in step 305 and proceeds to step 310.

In step 310, method 300 receives a request for managing a network across multiple domains. For example, an enterprise customer may subscribe to have its VPN managed by the network service provider and may request the service provider to isolate troubles as part of its subscription. For example, the customer may wish to know whether a network trouble is due to an RPM or a CER failure and also may wish to know which specific CERs are impacted by an RPM failure.

In step 315, method 300 creates an end-to-end topology between one or more Customer Edge Routers (CERs) and one or more Route Processing Modules (RPMs). For example, a topology that contains all CERs for the customer VPN may be created.

In step 320, method 300 creates a mapping table from one or more end-to-end topologies and stores the mapping table in a seed-file distributor. For example, one topology may illustrate that 10 CERs are attached to a specific RPM.

In step 325, method 300 instruments RPMs in an instance of an availability manager residing on the seed-file distributor acting as an IP availability manager that works with existing proxy located in the seed-file distributor.

In step 330, method 300 receives a notification (e.g., an alarm) for an RPM. For example, a fault management server connected to the RPM captures a fault notification and forwards the received notification to a seed-file distributor. In one embodiment, the notification may contain: whether or not a line is “up” or “down”, whether or not a sub-interface is shut or not-shut, whether or not a link is “up” or “down”, the RPM name, a severity measure and a sub-interface identification.

In step 340, method 300 determines whether or not a received notification affects one or more customers. For example, the fault management server 240 for the RPMs may filter received notifications to isolate those that may affect customers. The filtration may include processing a failure against sub-interface identifications that could impact one or more customers and ignoring sub-interface identifications that are not associated with customers. If the received notification affects one or more customers, the method proceeds to step 350. Otherwise, the method returns back to step 330.

In step 350, method 300 toggles the status of said RPM to “up” or “down” in accordance with received notification. For example, the seed-file distributor server receives a notification for an RPM and toggles the status of said RPM to “up” or “down.”

In step 360, method 300 distributes the received notification to one or more impacted availability managers. For example, the seed-file distribution server determines which availability managers are affected by the received notification and then distributes the received notification to one or more impacted availability managers.

In an optional step 380, method 300 provides information to a ticketing and/or customer notification system. For example, the availability manager using correlation of RPMs to CERs determines the CERs affected by a received failure notification and provides the information to a ticketing and/or customer notification system. The method then ends in step 399 or returns to step 330 to continue receiving more notifications/alarms.

It should be noted that although not specifically specified, one or more steps of method 300 may include a storing, displaying and/or outputting step as required for a particular application. In other words, any data, records, fields, and/or intermediate results discussed in the method can be stored, displayed and/or outputted to another device as required for a particular application. Furthermore, steps or blocks in FIG. 3 that recite a determining operation or involve a decision, do not necessarily require that both branches of the determining operation be practiced. In other words, one of the branches of the determining operation can be deemed as an optional step.

Those skilled in the art would realize the various systems or servers for provisioning, seed-file distribution, availability management, interacting with the customer, and so on may be provided in separate devices or in one device without limiting the scope of the invention. As such, the above exemplary embodiment is not intended to limit the implementation of the current invention.

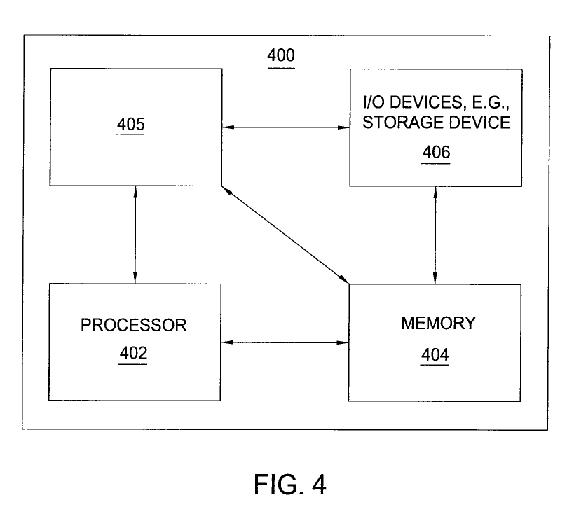

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for managing a network across multiple domains, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 405 for managing a network across multiple domains can be loaded into memory 404 and executed by processor 402 to implement the functions as discussed above. As such, the present method 405 for managing a network across multiple domains (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for managing a network across multiple domains, comprising:
storing a mapping table that correlates one or more Customer Edge Routers (CERs) with one or more Route Processing Modules (RPMs) in at least one seed-file distributor, where each of said one or more Customer Edge Routers (CERs) is monitored by at least one availability manager;
receiving an alarm associated with one of said one or more RPMs that affects one of said one or more CERs, where said alarm is received by one of said at least one availability manager that is monitoring said affected one of said one or more CERs; and
providing a status associated with said one of said one or more RPMs in accordance with said alarm.

2. The method of claim 1, wherein said alarm is received by one of a plurality of event correlation instances in said at least one availability manager that is monitoring said affected one of said one or more CERs.

3. The method of claim 1, wherein said alarm has been filtered to determine whether or not said alarm will affect one or more customers.

4. The method of claim 1, wherein said mapping table that correlates one or more Customer Edge Routers (CERs) with one or more Route Processing Modules (RPMs) is derived from at least one end-to-end topology between said one or more Customer Edge Routers (CERs) with said one or more Route Processing Modules (RPMs).

5. The method of claim 1, wherein said RPM provides a conversion of a Layer-2 packet to a Layer-3 packet.

6. The method of claim 1, wherein said alarm is received from a seed-file distribution server.

7. The method of claim 1, further comprising:
providing a notification to a ticketing system of said affected one of said one or more CERs.

8. The method of claim 1, further comprising:
providing a notification to a customer notification system of said affected one of said one or more CERs.

9. The method of claim 1, wherein said status indicates whether said one of said one or more RPMs is either up or down.

10. The method of claim 1, wherein said alarm comprises at least one of: whether or not a line is “up” or “down”, whether or not a sub-interface is shut or not-shut, whether or not a link is “up” or “down”, a RPM name, a severity measure, or a sub-interface identification.

11. A computer-readable medium having stored thereon a plurality of instructions, the plurality of instructions including instructions which, when executed by a processor, cause the processor to perform the steps of a method for managing a network across multiple domains, comprising:
storing a mapping table that correlates one or more Customer Edge Routers (CERs) with one or more Route Processing Modules (RPMs) in at least one seed-file distributor, where each of said one or more Customer Edge Routers (CERs) is monitored by at least one availability manager;
receiving an alarm associated with one of said one or more RPMs that affects one of said one or more CERs, where said alarm is received by one of said at least one availability manager that is monitoring said affected one of said one or more CERs; and
providing a status associated with said one of said one or more RPMs in accordance with said alarm.

12. The computer-readable medium of claim 11, wherein said alarm is received by one of a plurality of event correlation instances in said at least one availability manager that is monitoring said affected one of said one or more CERs.

13. The computer-readable medium of claim 11, wherein said alarm has been filtered to determine whether or not said alarm will affect one or more customers.

14. The computer-readable medium of claim 11, wherein said mapping table that correlates one or more Customer Edge Routers (CERs) with one or more Route Processing Modules (RPMs) is derived from at least one end-to-end topology between said one or more Customer Edge Routers (CERs) with said one or more Route Processing Modules (RPMs).

15. The computer-readable medium of claim 11, wherein said RPM provides a conversion of a Layer-2 packet to a Layer-3 packet.

16. The computer-readable medium of claim 11, wherein said alarm is received from a seed-file distribution server.

17. The computer-readable medium of claim 11, further comprising:
providing a notification to a ticketing system or to a customer notification system of said affected one of said one or more CERs.

18. The computer-readable medium of claim 11, wherein said status indicates whether said one of said one or more RPMs is either up or down.

19. The computer-readable medium of claim 11, wherein said alarm comprises at least one of: whether or not a line is “up” or “down”, whether or not a sub-interface is shut or not-shut, whether or not a link is “up” or “down”, a RPM name, a severity measure, or a sub-interface identification.

20. A system for managing a network across multiple domains, comprising:
means for storing a mapping table that correlates one or more Customer Edge Routers (CERs) with one or more Route Processing Modules (RPMs) in at least one seed-file distributor, where each of said one or more Customer Edge Routers (CERs) is monitored by at least one availability manager;
means for receiving an alarm associated with one of said one or more RPMs that affects one of said one or more CERs, where said alarm is received by one of said at least one availability manager that is monitoring said affected one of said one or more CERs; and
means for providing a status associated with said one of said one or more RPMs in accordance with said alarm.
